(19) United States
(12) Patent Application Publication
(10) Pub. No.: US 2008/0069325 A1
(43) Pub. Date: Mar. 20, 2008

(54) SYSTEM AND METHOD FOR AN INTELLIGENT COMMUNICATIONS DEVICE

(75) Inventor: Douglas Graham King, Plano, TX (US)

Correspondence Address: AKIN GUMP STRAUSS HAUER & FELD, LLP, P O BOX 688, DALLAS, TX, 75313-0688, US

(73) Assignee: UNIDEN AMERICA CORPORATION, Fort Worth, TX (US)

(21) Appl. No.: 11/532,714

(22) Filed: Sep. 18, 2006

(51) Int. Cl. H04M 1/00

(52) U.S. Cl. 379/157

(57) ABSTRACT

Disclosed is a unique intelligent communications device. The intelligent communications device in this disclosure can be embodied by an intelligent VoIP phone and can include a system and method of having more phone lines than can be shown at one time. Moreover, the device can also include a system and method of using the way a line appears on the phone to indicate status of that line and/or actions that can be taken using an associated line key. In addition, the device can also include a system and method for improved features for a conference call. Furthermore, the device can include the capability to port a line from one phone to another without network provisioning.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A “MICROFICHE APPENDIX”

Not Applicable.

### BACKGROUND OF THE INVENTION

The present invention generally relates to telecommunications devices, and specifically to an intelligent multi-functional communications device.

The telecommunications industry keeps witnessing rapid changes in the way people and organizations communicate. Many of these changes spring from the explosive growth of the Internet and from applications based on Internet Protocol (IP). The Internet has become an omnipresent means of communication, and the total amount of packet-based network traffic has quickly surpassed traditional voice (circuit-switched) network traffic, such as PSTN's (Public Switched Telephony Networks) and the like.

Technological advancements have helped telecommunication service providers, users, and suppliers realize that voice traffic and services may be one of the next major inroads to take full advantage of IP. This expectation is based on the impact of a new set of technologies generally referred to as Voice over IP (VoIP) or IP telephony.

VoIP supplies many unique capabilities to service providers and users who depend on IP or other packet-based networks. Some benefits include the following: cost savings, open standards and multi-vendor interoperability, integrated voice and data networks, and more intelligent phones.

In the case of cost savings, users can reduce or eliminate toll charges associated with transporting calls over the PSTN by moving voice traffic to IP networks. In the case for open standards and multi-supplier interoperability, both service providers and/or users can purchase equipment from multiple suppliers and eliminate their dependency on proprietary solutions. In the case for integrated voice and data networks, service providers and/or users can build truly integrated networks for voice and data by making voice “just another IP application”. These integrated networks not only provide the quality and reliability of today's PSTN, but they also enable users to quickly and flexibly take advantage of new opportunities within the changing world of communications. Finally, the case of more intelligent phones makes it possible to add additional features that could not be implemented in a traditional plain old telephone system (POTS) telephone.

Therefore, what is needed is a system and method for an intelligent phone with a robust plurality of advanced features.

### SUMMARY OF THE INVENTION

The present invention relates to a unique intelligent communications device. The intelligent communications device in this disclosure is embodied by an intelligent VoIP phone and includes embodiments that can include a system and method of having more phone lines than can be shown at one time. Moreover, embodiments of the phone can also include a system and method of using the way a line appears on the phone to indicate status of that line and/or an action that can be taken using an associated line key. In addition, embodiments of the phone can also include a system and method for improved features for a conference call. Furthermore, embodiments of the phone can include the capability to port a line from one phone to another without network provisioning.

Therefore, in accordance with the previous summary, objects, features and advantages of the present disclosure will become apparent to a person of the ordinary skill in the art from the subsequent description and the appended claims taken in conjunction with the accompanying drawings.

### BRIEF DESCRIPTION OF THE DRAWINGS

FIG. 1 is a diagram of an exemplary intelligent phone;

FIG. 2 is a diagram of the screen of the phone along. with several keys;

FIGS. 3-5 are diagrams of the screen according to some embodiments of the invention;

FIG. 6 is a diagram of the screen according to some embodiments of the invention; and

FIG. 7 is a diagram of the screen according to some embodiments of the invention.

### DETAILED DESCRIPTION

The present disclosure can be described by the embodiments given below. It is understood, however, that the embodiments below are not necessarily limitations to the present disclosure, but are used to describe typical implementations of the invention.

Embodiments of the present invention can provide a unique method and system for an improved intelligent phone. It is understood, however, that the following disclosure provides many different embodiments, or examples, for implementing different features of the invention. Specific examples of components, signals, messages, protocols, and arrangements are described below to simplify the present disclosure. These are, of course, merely examples and are not intended to limit the invention from that described in the claims. Well known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art. Details regarding control circuitry described herein are omitted, as such control circuits are within the skills of persons of ordinary skill in the relevant art. While various features are shown and described within the context of different embodiments, additional embodiments can include any combination of any of the features described herein.

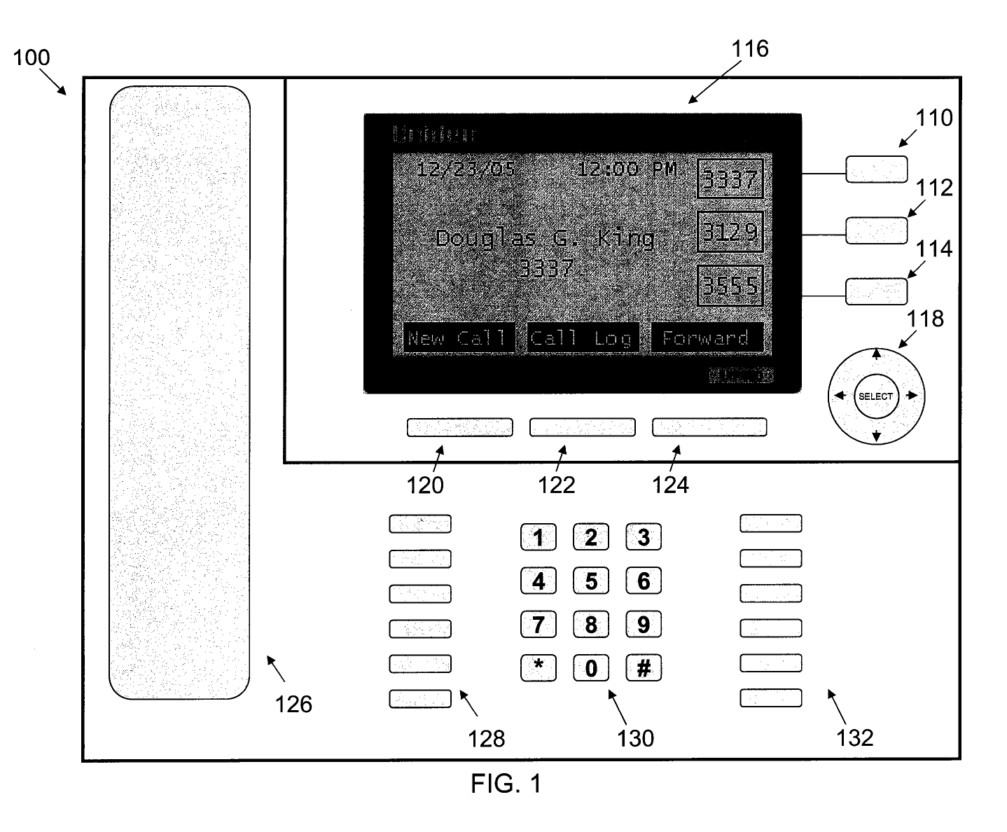

FIG. 1 illustrates an exemplary intelligent phone 100. The phone utilizes VoIP technology and has a first line key 110 that activates a first line that is associated with an extension 3337 in this example as indicated by the “3337” extension icon. Similarly, a second line key 112 is provided that activates a second line (extension 3129 in this example), and a third line key 114 that activates a third line (extension 3555 in this example). Note that the extension icons are also referred to herein as “line appearances.” The phone 100 also includes, as a display, a screen 116 that displays information about options and lines for the user.

The phone 100 also includes a navigation toggle key 118 along with a first function key 120, a second function key 122, and a third function key 124. The first function key 120 is associated with a first function that is indicated by a function icon, which in this example is a “New Call” function icon. Similarly, the second function key 122 is associated with a second function (“Call Log”), and the third function key 124 is associated with a third function (“Forward”). The phone also includes a handset 126, a first set of additional feature keys 128, a traditional number pad 130, and a second set of additional feature keys 132.

While the keys 110, 112, 114, 118, 120, 122, 124, 128, 130, and 132 are shown as push-buttons, any type of input device, including the use of touch-screen controls, can be used as implementations of one or more of any of the keys 110, 112, 114, 118, 120, 122, 124, 128, 130, and 132. For example, in some embodiments, the extension icons (e.g., the “3337,” “3129,” and “3555” icons) can be aligned with touch-sensitive regions of the screen 116 and can serve as line keys 110, 112, and 114. Also, in some embodiments, the function icons (e.g., the “New Call,” “Call Log,” and “Forward” icons) can be aligned with touch-sensitive regions of the screen 116 and can serve as function keys 120, 122, and 124. In still further embodiments, the navigation key 118 or other control can be used to navigate and select the displayed icons and activate the function or line associated with a selected icon. Alternatives to the navigation key 118 can include plural keys, a thumb wheel, a tilt wheel, a track ball, a touch pad, and/or any other type of input device.

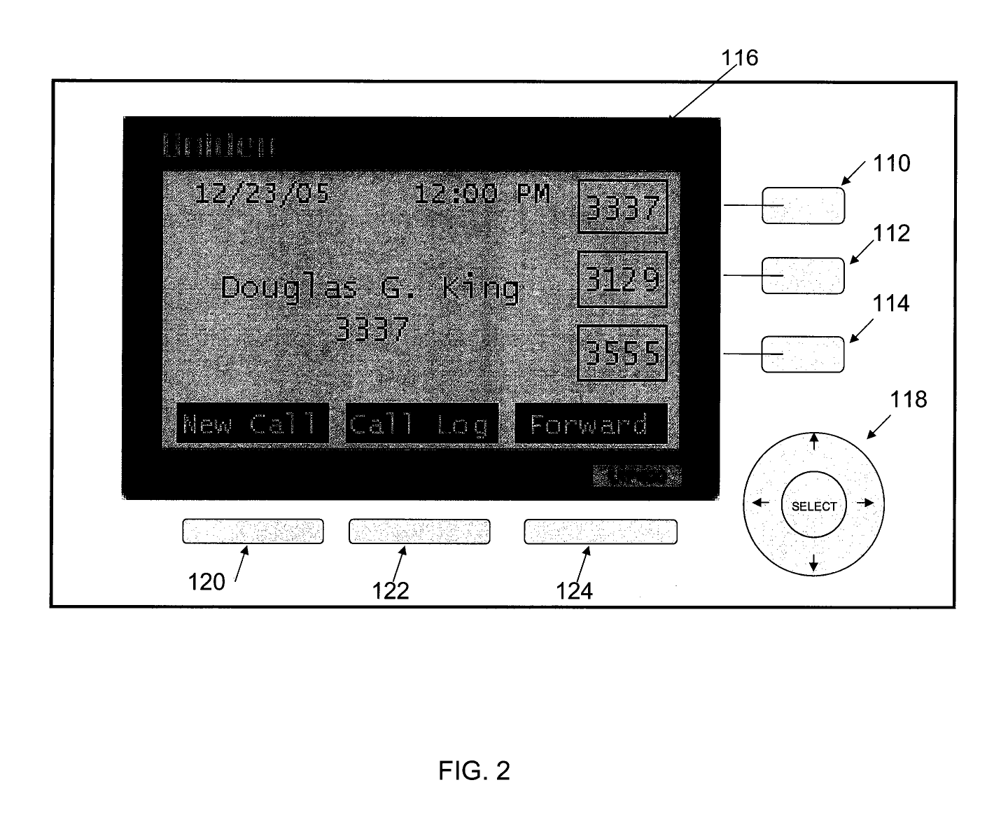

FIG. 2 shows an enlarged view of the screen 116. The screen 116 includes display of the current date and time, line appearances of the telephone lines (in this example, 3337, 3129, and 3555), the current actions available for the active call (in this example, New Call, Call Log, and Forward), and a general text display. The general text display, also referred to herein as a “call appearance,” in this example includes the name of the person assigned to active call indicating that 3337 is active and assigned to Douglas G. King.

Some phones can be used to control more than one line appearance (phone number/telephone line). In the case of private branch exchange (PBX) phones, this is done by providing a line key for each terminated line. This key can be used for answering that line or for generating outbound calls. Although a VoIP phone can control more line appearances than traditional POTS phones, there has still been only one line per line key. Thus, the traditional method for gaining access to a large amount of lines is through the use of extra keys. Frequently, extra keys are added to a phone through the use of additional banks of keys that are purchased as an accessory to the original phone. However, line keys on a phone usually take up a considerable amount of real-estate on a phone. If fewer than the number of line keys on a phone are needed, then the keys are likely wasted. In addition, if a phone has all its line keys mapped to lines already, it is not possible to add an additional line without a line key extension.

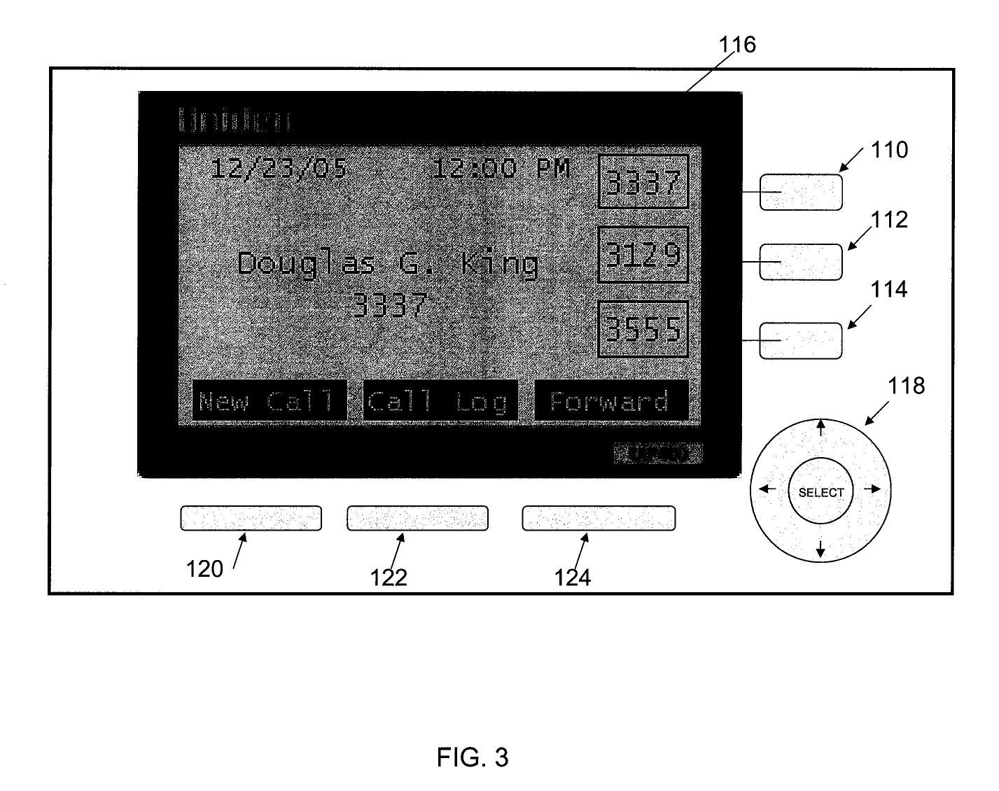

Embodiments of the invention can include a method of having more telephone lines than can be displayed at one time. Some embodiments can include “dynamic” line appearances. According to some embodiments, specific line appearances are not mapped to just one line key. FIGS. 3-6 illustrate an example of scrolling though a set of three extensions, although many more lines could be implemented.

Traditionally, a phone has a default line. This is the line that goes off hook when the handset is taken off its cradle. The default line in FIG. 3 is extension 3337, which is assigned to Douglas G. King. Thus, in this example, the line appearance associated with the line key 110 is the default line. However, through the use of up/down navigation key 118, the default line can be changed to a different extension.

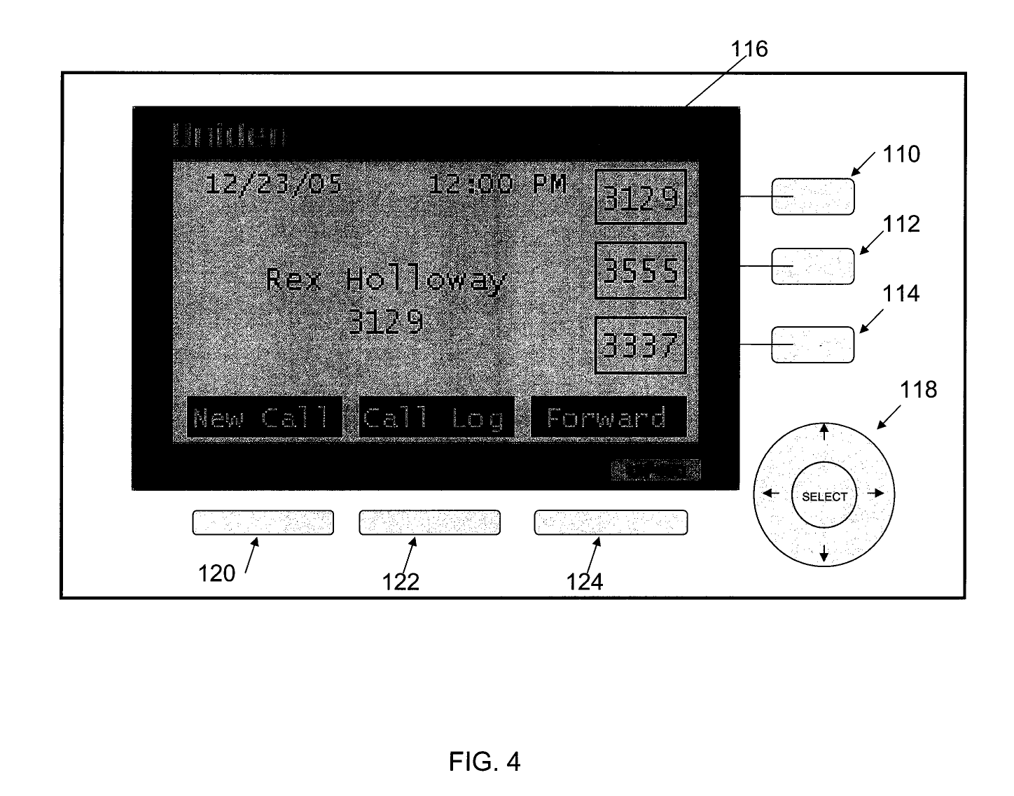

For example, if the up/down navigation key 118 is pressed on the up arrow, the display shown by the screen 116 changes from the display shown in FIG. 3 to the display shown in FIG. 4. Thus, the default line becomes extension 3129, which is assigned to Rex Holloway.

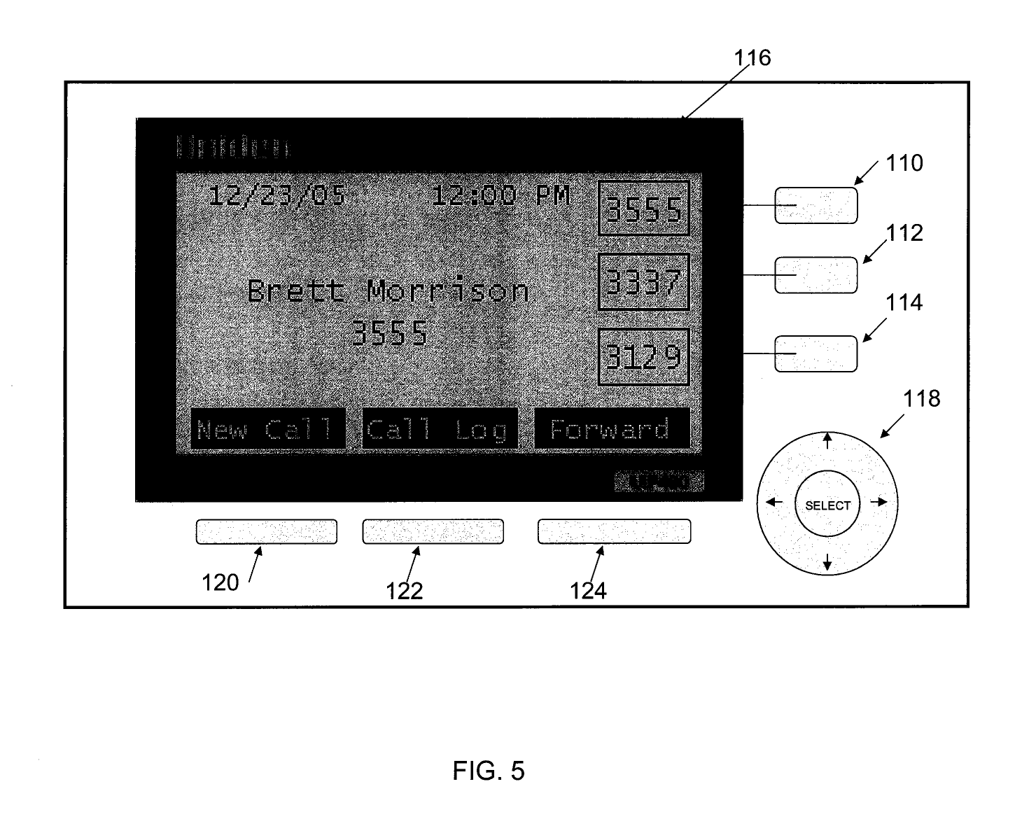

If the up/down navigation key 118 is again pressed on the up arrow, the display changes from the display shown in FIG. 4 to the display shown in FIG. 5, and the default line becomes extension 3555, which is assigned to Brett Morrison.

While there are only three line appearances in the example of FIGS. 3-5, it is possible to support many more extensions by allowing extensions to rotate off the limited number of line keys. For example, as a result of the above-described transition that occurs from the view shown in FIG. 3 to the view shown in FIG. 4, the line appearance associated with line key 114 can be a fourth extension that was not shown in FIG. 3 rather than the extension 3337, which was associated with line key 110 in FIG. 3.

In addition, such embodiments of the invention can include, or be used with, PBX phones, Multi-line home phones, and computer based telephony as well as VoIP phones.

Embodiments of the invention can also include features related to conferencing. A common function of an enterprise phone is the conferencing of multiple calls. Calls are usually added to a conference by either combining existing calls or by dialing in new conference attendees. Once a call is in a conference, it is difficult to manage the various individual conference attendees. Some systems allow you to “drop” attendees in the reverse order they are added but holding and transferring individual call appearances is not possible.

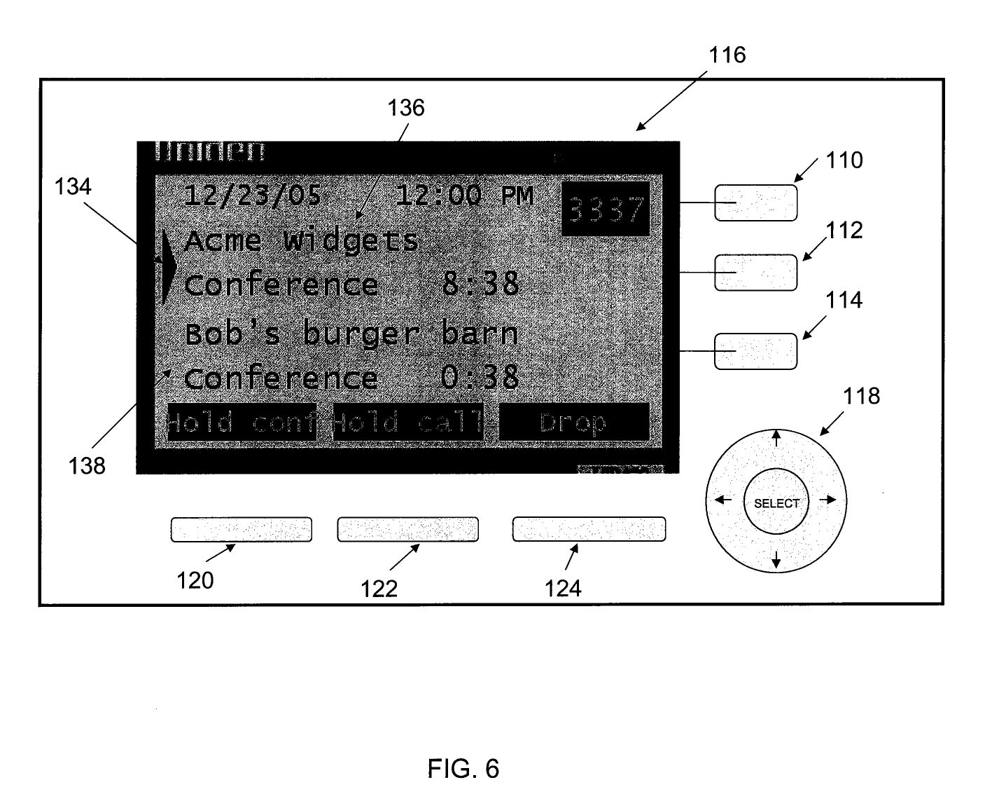

Embodiments of the invention can allow for more flexibility for conference calls. FIG. 6 illustrates some examples of options that can be implemented while a conference call is held. In the embodiment shown in FIG. 6, the screen 116 shows a first call appearance 136 and a second call appearance 138. In the illustrated embodiment, each call appearance 136, 138 includes a party name, type of call, and call duration for the respective party. The first call appearance 136 includes the name “Acme Widgets,” the type of call as “Conference,” and the call duration (i.e., the length of time that Acme Widgets has been a party to the conference call) of “8:38.” Similarly, the second call appearance 138 includes the name “Bob's burger barn,” call type “Conference,” and duration “0:38.” In alternative embodiments, the type of information included in the call appearances can vary.

Embodiments can allow for display of any number of call appearances on the screen 116 at any given time. Embodiments can also allow a user to change the call appearances appearing on the display. For example, if there is a party to the conference call illustrated in FIG. 6 other than the user and the two parties associated with the first and second call appearances 136 and 138, then the user can use the navigation key 118 to scroll the call appearances in order to view a third call appearance (not shown) associated with the additional party.

The functions associated with the function keys 120, 122, and 124 and/or the line appearances associated with the line keys 110, 112, and 114 can be different for different parties to the conference call. An indicator 134 shows that the first call appearance 136 is active at this point, in the sense that the line appearances/functions presently appearing on the display are those that relate to the party associated with the first call appearance 136. In this example, the current actions that can be taken for ACME Widgets are: (1) put them on hold by depressing the second function key 122, or (2) drop the call from conference call by depressing the third function key 124. In addition, the entire conference call can be put on hold if the first function key 120 is depressed. Another option that can be implemented is to transfer the active call. Although this option is not displayed on the screen 116, the navigation key 118 can be used to scroll through the functions, thereby changing the functions associated with one or more of the function keys 120, 122, and 124, until the “transfer” function is displayed.

Similarly, the navigation key 118 can be used to move the indicator 134, or alternatively scroll the call appearances 136 and 138, in order to make the second call appearance active. Although only two callers are shown on screen 116, the up/down arrows on the navigation button 118 can be used to scroll through other callers on a conference call that are not displayed in the view shown in FIG. 6.

Moreover, such embodiments of the invention can include, or be used with, PBX phones, Multi-line home phones, and computer based telephony as well as VoIP phones.

Embodiments of the invention can also include features related to line appearances (e.g. how a line appears on screen 116). Traditional PBX phones provide a fixed number of line appearances (e.g. an LED associated with that line key is on or blinks). Often a phone with multiple line appearances will only have one line associated with them. When this is the case, all of the line keys that could have been used for other lines (numbers) can now be used to manage the same line. In this way, when a call is placed on Hold, the LED associated with one of the line keys blinks to show that that call is held and another line key can be used to get a dial tone.

Traditional VoIP phones have soft keys that are contact sensitive that give an option to resume a held call or to create a new call on a held line. However, there are several situations when line keys could produce ambiguous results in a phone that cannot show the status of different call appearances. For example, the following scenarios can produce ambiguous results: if a call is on hold on one line and a second line is available, it can be ambiguous to a user whether lifting the handset will cause the call on hold to “resume” or will activate the second available line; if a call is on hold on one line and there is an incoming call on a second line, it can be ambiguous to a user whether lifting the handset will cause the call on hold to “resume” or will activate the line with the incoming call; and if there is an incoming call while the handset is off the hook, it can be ambiguous to a user whether replacing the handset will terminate the incoming call.

Embodiments of the invention can use variations of line appearances as an unambiguous method of providing for the use of line keys, e.g., to resume a held call, create a new outbound call, or to answer an incoming call. In some embodiments, a line appearance for each possible use of the line can be created and displayed on the screen 116.

When phones with a dynamic user interface (not necessarily an IP phone) are in a state where pressing the line key would produce an ambiguous result, the lines are updated with a new line appearance that shows, e.g., through the use of visible states (such as slow blinking, rapid blinking, lit, unlit, etc), what the result of hitting that key will be.

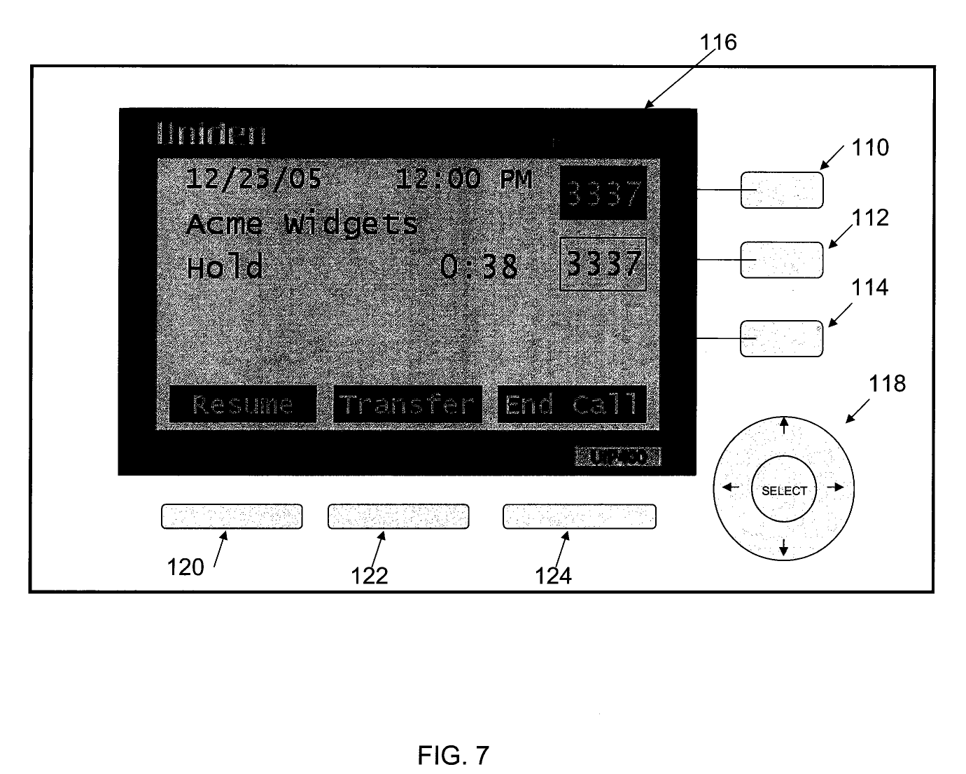

FIG. 7 illustrates an example of using multiple line appearances to show different options for line 3337. As the screen 116 indicates in FIG. 7, ACME Widgets is on hold. The uppermost 3337 line appearance is shaded, which can be understood by the user to mean that pressing the associated line key 110 will resume the held call. The next 3337 line appearance is not shaded, which can be understood by the user to mean that pressing the associated line key 112 will activate a second line on the 3337 extension. Other line appearances can be used to indicate different options, such as slow or fast blinking or variations in color. In addition, as shown on the bottom of the screen 116, the call from ACME Widgets can be resumed by depressing the first function key 120, or transferred by depressing the second function key 122, or terminated by depressing the third function key 124.

Embodiments of the invention can include features related to porting a line from one phone to another. Line porting is an enterprise telephony feature which allows multiple physical telephones to be configured with the same extension (number). This feature is useful for situations where: multiple people are equally relevant to the line (e.g., call centers); administrative assistants answering for someone away from their phone; and people who wish to cover each other's line.

Traditional phones are configured to operate on a specific line (i.e., extension or telephone number) or group of lines such that changing the line of a phone has been a relatively complex task requiring the services of a trained technician. This is inconvenient for people that wish to have an extension temporarily associated with a phone.

Embodiments of the invention can include more convenient methods of manually adding a line to a phone. Embodiments of the invention can make it possible for a user to add a phone number to a phone with the use of a few keystrokes. No provisioning or administrative intervention is necessary to support these methods.

One method for adding a line to a phone is to provide a function that can be associated with any of the function keys 120, 122, 124 for adding a new line. For example, the user can use the navigation key 118 to scroll to a new option called “New Line.” It would be displayed at the bottom of screen 116 similar to the “Resume,” “Transfer,” and “End Call” options. The appropriate function key 120, 122, 124 could then be depressed to activate the “,New Line” option. The screen 116 would then prompt the user to enter the new line through the use of the phone number pad 130 (shown in FIG. 1).

A similar “End Line” option can also be included to drop a line from the phone. Again, the navigation key 118 can be used to display the option “End Line” and the associated user key can be used to drop the line.

However, other methods could be used to add or drop a new line, such as entering a specific code through the phone number pad 130 and then following instructions displayed on the screen 116 or through a voice menu. In addition, a specific key, e.g., one of the additional feature keys 128, 132, could be provided on the phone 100 for adding or dropping a new line.

In some embodiments, the process of adding a line can include requiring entry of a security code, for example a pin number, in order to prevent unauthorized users from adding lines and/or to prevent unauthorized addition of a specific line. For example, a security code can be required for performing the “New Line” function; alternatively or in addition, a security code can be associated with a particular line such that the particular line cannot be added to a phone unless the correct security code is entered.

In addition, such embodiments of the invention can include, or be used with, PBX phones, Multi-line home phones, and computer based telephony as well as VoIP phones.

The above description of the disclosed embodiments is provided to enable a person of ordinary skill in the art to make or use the present invention. Various modifications to these embodiments will be readily apparent to those skilled in the art, and generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

We claim:

1. An intelligent communications device suitable for use with a plurality of telephone lines, the device comprising:
a line key for activating an associated one of the plurality of telephone lines;
a display for illustrating the associated telephone line on the device; and
a navigation key for allowing a user to change which of the plurality of telephone lines is associated with the line key.

2. The device of claim 1, wherein the navigation key is for allowing the user to change which of the plurality of telephone lines is associated with the line key at least in part by scrolling through a telephones lines that would otherwise not be listed on the display.

3. The device of claim 1, wherein the navigation key is further for allowing the user to change which of the plurality of telephone lines is a default line for the device.

4. The device of claim 1, further comprising an input interface for dialing a telephone number.

5. The device of claim 1, wherein the line key is one of a plurality of line keys of the device, wherein each line key is associated with a respective telephone line, and wherein the navigation key is for allowing the user to change which of the plurality of telephone lines is associated with each of the plurality of line keys.

6. The device of claim 5, wherein the plurality of line keys includes fewer line keys than the total number of the plurality of telephone lines.

7. An intelligent communications device suitable for use with a plurality of telephone lines, the device comprising:
a first line key for activating an associated telephone line;
a second line key; and
a display for, during a call on the associated telephone line, illustrating:
a call appearance that includes information about the call,
a first line appearance associated with the first line key, and
a second line appearance associated with the second line key,
wherein, during the call, the first line appearance has a visible state that is different from that that of the second line appearance, and
wherein, during the call, the first line key is for performing a first action on the associated telephone line and the second line key is for performing a second action on the associated telephone line.

8. The device of claim 7, wherein the call can be put on hold and while the call is on hold at least one of the first and second actions is for resuming the call.

9. The device of claim 7, wherein the call can be put on hold and while the call is on hold at least one of the first and second actions is for creating a new outbound call.

10. An intelligent communications device suitable for use with a plurality of telephone lines and having a conferencing capability, the device comprising:
a plurality of line keys, each associated with a respective telephone line;
a plurality of function keys, each associated with a respective function;
a display for illustrating telephone lines and functions on the device; and
a navigation key for allowing a user to scroll through a plurality of call appearances involved in a conference call.

11. The device of claim 10, wherein the navigation key allows the user to scroll through call appearances that otherwise would not appear on the display.

12. The device of claim 10, wherein the navigation key allows the user to select one of the plurality of call appearances involved in the conference call.

13. The device of claim 12, wherein the functions associated with the function keys are updated for each call appearance selected by the user to reflect functions available for the selected call appearance.

14. The device of claim 13, wherein at least one of the functions is for placing a party associated with the selected call appearance on hold and at least one of the functions is for placing all parties to the conference call on hold.

15. The device of claim 13, wherein at least one of the functions changes when the selected call appearance is changed from a party that is on hold to a party that is not on hold.

16. An intelligent communications device suitable for use with a plurality of telephone lines and having a portable line capability, the device comprising:
a plurality of line keys, each for activating a respective associated telephone line appearance;
a plurality of function keys, each for initiating a respective associated function; and
a display for illustrating the associated telephone line appearances and associated functions on the device,
wherein the plurality of functions includes a new line function for activating a new telephone line appearance on the device.

17. The device of claim 16, wherein the plurality of functions includes an end line function for ending the new telephone line appearance on the device.

18. An intelligent communications device suitable for use with a plurality of telephone lines and having a portable line capability, the device comprising:
a plurality of line keys, each for activating a respective associated telephone line appearance;
a plurality of function keys, each for initiating a respective associated function; and
a display for illustrating the associated telephone line appearances and associated functions on the device; and
a pre-programmed code for allowing a user to port a new line appearance to the device.

19. The device of claim 18, wherein the display illustrates instructions for the user to add the new line appearance to the device.

20. The device of claim 18, wherein the device instructs the user to add the new line appearance by voice instructions.

21. The device of claim 18, wherein the pre-programmed code comprises a security code.
